(19) United States
(12) Patent Application Publication
(10) Pub. No.: US 2003/0220802 A1
(43) Pub. Date: Nov. 27, 2003

(54) Promotion/demotion of entries in business registries

(76) Inventors: Brent Wayne Cossey, Euless, TX (US); Gregory Peter Fitzpatrick, Keller, TX (US); Robert S. Keller, Colleyville, TX (US)

Correspondence Address: IBM Corporation, Intellectual Property Law, Internal Zip 4042, 8051 Congress Avenue, Boca Raton, FL, 33487, US

(21) Appl. No.: 10/153,084

(22) Filed: May 22, 2002

(51) Int. Cl. G06F 17/60

(52) U.S. Cl. 705/1; 705/10; 705/11

(57) ABSTRACT

This concerns a process for maintaining and using business registry (BR) databases. Such BR's, maintained and/or controlled by businesses designated ‘target’ enterprises, contain entries associated with businesses or individuals seeking consideration for trusted business relationship associations with the target enterprise, such entities designated presently as ‘seeking’ entities. These entries contain ‘member status’ code values designating levels of trust associated with respective seeking entities, and information parameters subject to modification by the target enterprise which effectively constitute criteria for raising and lowering status values assigned to individual entries. A presently disclosed options list mechanism allows the target enterprise to modify the information constituting the criteria for trust status level assignment. The options list content is so organized that when an associated BR is searched, member status values assigned to individual entries may be automatically upgraded or downgraded, with the respective effects that associated trust levels of respective seeking entities may be automatically promoted to higher status or demoted to lower status.

### BACKGROUND OF THE INVENTION

Business registries (BR's) are searchable database files—public or private—which are used to store information about business enterprises and other entities. Such information may be useful for evaluating entities that are being considered for trusted business associations; e.g. for evaluating business enterprises as potential candidates for partnership ventures, or for evaluating individuals considered for trusted employment or consulting functions. Typically, entries in a BR file consist of information about entities that are candidates for trusted business relationships relevant to the business purpose of the respective BR. For discussions to follow, each candidate associated with a BR entry is termed a “seeking” entity, and a business considering such candidates is termed a “target” enterprise. Access to the BR file is generally controlled by one or more authorized representatives or agents of the target enterprise.

A problem addressed by the present invention is to allow for search of such BR files in a manner ensuring that consideration of candidates is efficiently restricted to seeking entities meeting specific acceptance threshold standards variably established by the target enterprise.

### SUMMARY OF THE INVENTION

The present invention concerns an improved system and method for maintaining and managing business registry files (BR's).

Features of this system are that it enables a target enterprise to:

a) reliably search the registry and select as candidates seeking entities meeting predetermined criteria of trustworthiness; b) assign numerical ratings to all entries reflecting their levels of trustworthiness relative to functions and/or positions currently being evaluated; c) allow for automatic promotion and demotion of assigned ratings based on criteria set by the target enterprise; and d) allow the target enterprise to modify the criteria for promotion and demotion at any time.

The invention preferably is implemented as a software application for general purpose computer systems.

In the presently contemplated arrangement, the target enterprise either owns the system for managing its BR files, or otherwise controls entry of information therein. Each new entry into a BR is assigned a “provisional” trust rating denoting a minimal level of trustworthiness for the business purpose of the respective BR. The entry, and its associated seeking entity, are kept at the provisional trust level until the respective seeking entity has met criteria set by the target enterprise; e.g. tests of legitimacy, business ethics, reliability, etc. When an entity passes these tests, it is promoted to a higher level of trust by raising the rating of its BR entry.

This promotion may be automatic, in the sense that it need not require an immediate interaction between the computer system managing the BR file and a representative of the target enterprise. Criteria of these tests are subject to modification by the target enterprise at any time. Thus, depending upon the sensitivity of ventures associated with the business purpose of a BR, the criteria may be varied; e.g. to increase the severity of the tests as associated ventures become more sensitive, and decrease their severity as the sensitivity decreases. The criteria may include numerical factors representing event thresholds as well as rules applicable in a logical context for qualifying promotion of a seeking entity. Such factors and rules may also be applied in a negative context for determining conditions under which the entry of a trusted seeking entity could be demoted to a lower level of trust.

In practice, a search in a BR may evaluate entries assigned to various levels of trust; including entries having provisional trust ratings. As noted earlier, each newly entered entry is assigned a provisional/lowest rating. Depending upon the business purpose under consideration, the target enterprise may choose to consider either all entries in a BR or only entries having trust ratings higher than provisional. For example, if the business objective is to locate potential suppliers of a specific commodity or service, the target enterprise may exclude consideration of provisional entries and allow dissemination of Requests for Proposal (RFP's) only to enterprises having entries assigned to a highest trust level. On the other hand, if the objective involves a low-risk function (e.g. preliminary negotiations for certain non-essential services), the target enterprise may choose to review provisional entries, and thereafter consider promotion of respective entries to status higher than provisional, conditional upon the associated entry meeting an acceptance threshold (or set of rules) set by the target enterprise.

Although the present system usually would be restricted to two rating categories of two trust, i.e. a provisional/low level and a “trusted”/high level, it is contemplated that intermediate rating categories could be warranted in some circumstances.

In use, the present system monitors business activities of the target enterprise and communications from candidate entities having entries in the BR, and, upon events determined by the target enterprise, it evaluates entries of entities associated with the events. Results of such evaluations are used to selectively promote and demote trust ratings assigned to respective entries. Criteria applied to such actions may have arbitrary levels of complexity, depending upon requirements set by the target enterprise, and also may be varied by or for the target enterprise at any time. Promotion/demotion actions may be applied either automatically, by the computer system managing the BR, or manually by representatives of the target enterprise.

The foregoing and other features, objects, benefits and advantages of the invention will be more fully understood and appreciated by considering the following description.

### BRIEF DESCRIPTION OF DRAWINGS

FIG. 1 schematically illustrates a Business Registry (BR) consistent with this invention;

FIG. 1A illustrates a database file suitable for embodying the BR exemplified in FIG. 1;

FIG. 2 illustrates an options list, associated with the database of FIG. 1A, containing criteria for recognition of events requiring evaluation of BR entries, and criteria for determining when trust ratings of evaluated entries merit promotion and demotion considerations.

FIG. 3 is a flowchart illustrating processes of operation of a system conforming to this invention, using information parameters shown in FIGS. 1A and 2; and

FIG. 4 is a flowchart illustrating details of processes indicated more generally in FIG. 3.

### DETAILED DESCRIPTION

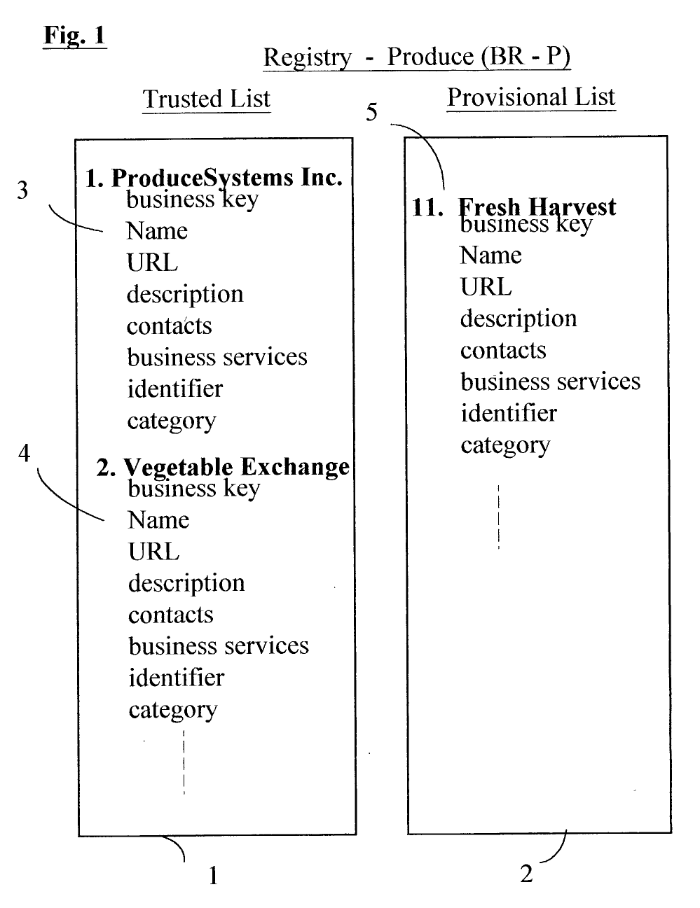

FIG. 1 schematically illustrates an example of a business registry ‘BR-P’ associated with produce (fruits, vegetables, etc.). This figure shows entries assigned to two lists associated with two levels of trust ratings; a trusted list 1 and a provisional (least trusted) list 2. However, although only two such lists are illustrated, it will be understood that additional lists may be used to associate with entries having trust ratings intermediate those of lists 1 and 2.

In the illustrated example, trusted list 1 contains two entries—‘Produce Systems Inc’ and ‘Vegetable Exchange’, shown respectively at 3 and 4—and provisional list 2 contains a single entry, ‘Fresh Harvest’ shown at 5.

Each BR entry includes a number of information parameters. Some of these are shown in FIG. 1, and others, including trust ratings and criteria for their assignment and modification, are shown in FIG. 1A. Parameters shown in FIG. 1 are defined as follows:

Business Key—a number uniquely identifying the respective seeking entity

Name—name of respective entity (e.g. company name or ‘doing business as’ name, etc.)

URL—Universal Resource Locator (website address) of respective entity

Description—brief description of respective entity and its capabilities

Contacts—Main points of contact at entity (address, phone number, key employees, etc.)

Business Services—business service(s) provided by respective entity

Identifier—number uniquely identifying business area of respective entity

Category—type of industry/business in which respective entity operates.

The information entries for a BR of the type shown in FIG. 1 is generally organized into a database file which can be searched, in a manner discussed later, to extract the trust status lists shown in FIG. 1; i.e. trusted and provisional lists, and any intermediate lists if applicable. As presently contemplated, each such database file is associated with a single BR.

FIG. 1A illustrates the logical organization of a typical BR of the type being considered. Consecutive entries are shown at 11 and 12. Exemplary information parameters for entry 11—shown at 13, 13.1, and 14-16—are also representative of corresponding parameters in all other entries. As seen at 13, in addition to the parameters shown in FIG. 1, parameters 13 of entry 11 include function 13.1, designated ‘other’ which is associated with other parameters that are more specifically relevant to the present invention. Each entry has ‘other’ information entry corresponding to that shown at 13.1.

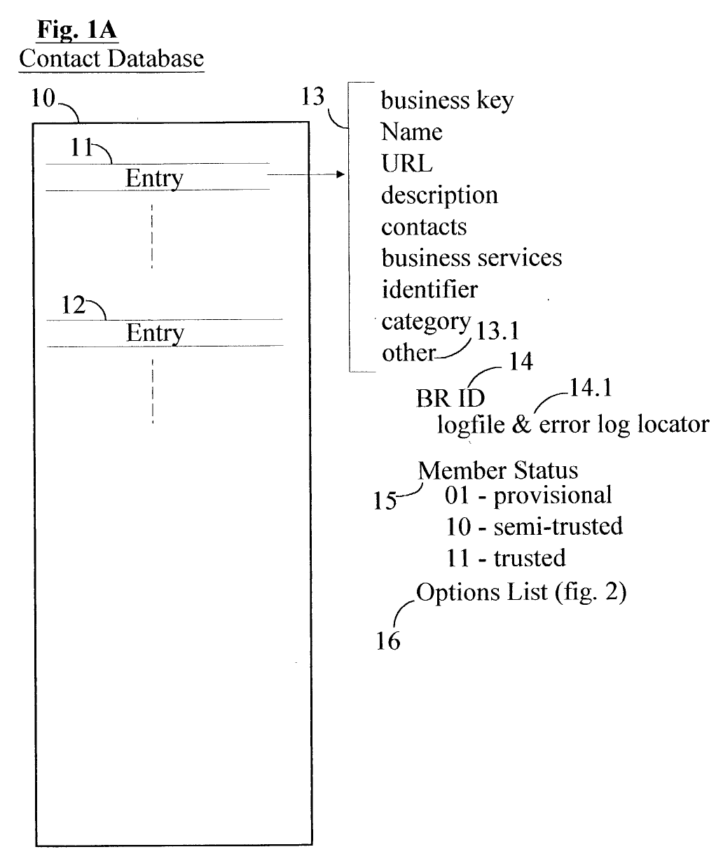

Specific examples of such ‘other’ information are shown at 14, 15 and 16. It will be understood, from the description of FIG. 2 to follow, that these are representative examples, and that a BR as presently contemplated may have other information not specifically shown in either FIG. 1A or FIG. 2.

The example of ‘other’ information at 14 is a identifier number, ‘BR ID’, unique to the respective BR. As suggested at 14.1, this number serves as a link for locating a logfile and an error log file which are associated with the respective BR and contain logged information pertaining to processing of individual entries.

The ‘other’ information at 15 consists of a member status number defining the respective entry's trust rating. In the illustrated example, this number is a two digit binary value denoting that rating as one of: ‘provisional’ (value ‘01’ in the example), ‘trusted’ (value ‘11’ in the example), and ‘semi-trusted’ (value ‘10). Member status information 15 of all BR entries is useful to enable the target enterprise to extract the provisional and trusted lists of FIG. 1, as well as lists pertaining to levels of trust intermediate provisional and fully trusted. Those skilled in the database arts understand that extraction of such lists would involve execution of presently conventional database search operations.

Other significance and potential uses of member status information 15 is as follows. Entities whose entries have ‘provisional’ status may add basic information 13 to the BR (or have such information added by the target enterprise), do not have access to ‘other’ information 13.1, and generally would not be subject to immediate consideration for a business relationship involving trust. Entities having ‘trusted’ status are those which have met criteria established by the target enterprise relative to business purposes of the respective BR, and are considered eligible to participate as a trusted business partner or associate in any venture associated with the respective BR. Entities having ‘semi-trusted’ status are entitled to more favorable consideration than those having provisional status and less favorable consideration than those with trusted status.

As noted earlier, as an entry is placed initially into a BR it is assigned provisional status, and is subject to promotion to more trusted status only when it has passed tests of trustworthiness defined by the target enterprise, criteria for which are subject to modification at any time by the target enterprise (refer to descriptions of FIGS. 2-4 to follow).

The ‘other’ information example at 16 includes information associated with the trust test criteria mentioned above. This includes information in and locators for the Options list of FIG. 2. That list effectively contains criteria determining events at which an entry may be evaluated for promotion and demotion, and rules and thresholds defining conditions under which an entry could actually be promoted or demoted (i.e. have its member status respectively increased or decreased in ‘trust’ value). As noted earlier, such promotion may be either automatic or via manual intervention of the target enterprise.

FIG. 2 illustrates an options list, for enabling the target enterprise to establish and modify criteria for upgrading and downgrading ‘member status’ values 15 of individual entries. Entries in this list having ‘provisional status’ relative to an associated BR are effectively on a ‘waiting list’ relative to that BR, and entries having ‘trusted’ status relative to the same BR are effectively on a ‘trusted list’ for the respective BR. Thus, the options list effectively enables the target enterprise to establish criteria for promoting entries from the waiting list to the trusted list and demoting entries from the trusted list to the waiting list. It is important to understand that parameters illustrated in FIG. 2 are intended to serve as examples of what a target enterprise might include on their options list, and that many other parameters may be used by different target enterprises to establish their criteria for promotion/demotion.

The options list (FIG. 2) contains initially blank entries at 21 corresponding to those shown at 13 in FIG. 1A (i.e. business key, name, URL, etc.). A drop-down list at 22 contains names of seeking entities having entries in the associated BR. These names may be associated with all entries in the BR, or they can be restricted by the target enterprise to those associated with specific lists; i.e. the provisional list, trusted list, etc. Upon selection of a name from list 22, entries 21 are filled in with database information associated with the respective name and BR; i.e. information as shown at 13, FIG. 1A.

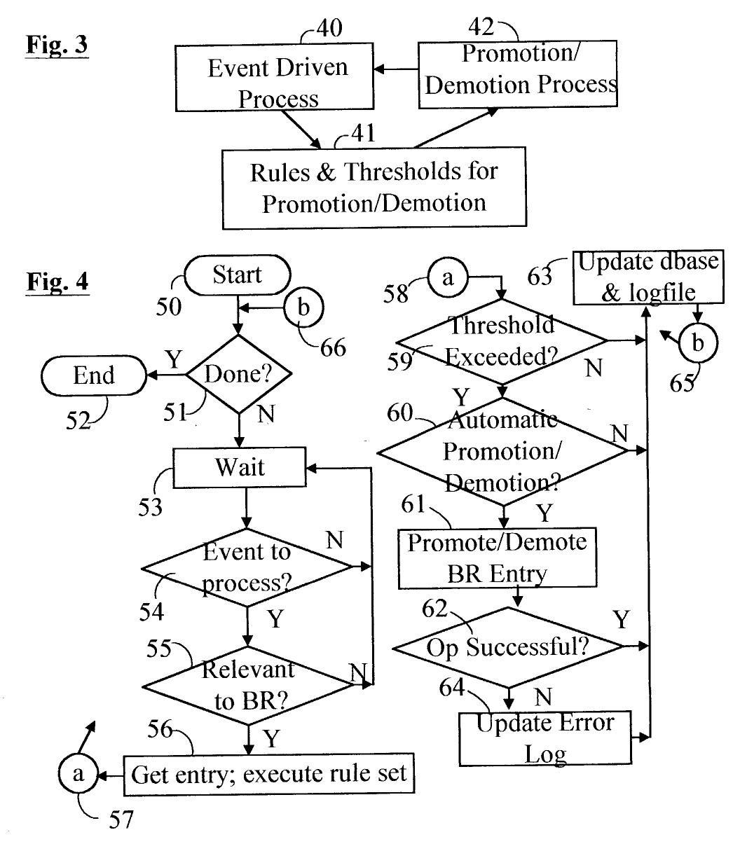

The options list also contains spaces 23-35, containing headings and spaces that are initially blank when the list is accessed. The headings are fixed for all accesses to the options list and the initially blank spaces contain information which is extracted from the BR database when an entry name is selected from list 22. The information in all of these spaces 23-35 is associated with criteria relevant to promotion and demotion of member status ratings. This information is set initially into the database by the target enterprise (or authorized representative), and it may be modified by the target enterprise at any time during existence of the BR. Some of the information in these spaces (both headings and other spaces) also may be automatically modified during system access to the Options List for evaluating trust ratings of individual BR entries (refer e.g. to description of FIG. 4 below).

Heading 23, ‘Time Allowed on Waiting List’, is associated with space 24. Space 24 indicates a number of days a respective entry, if on a ‘waiting list’ in the associated BR, can be allowed to remain on that list.

Heading 25, ‘Days Left to Expiration’, is associated with space 26. Space 26 indicates a number of days remaining until the respective entry expires as a waiting list entry for the BR.

Heading 27, ‘Date to be Promoted’, is associated with space 28; that space indicating a date on which the respective entry, if on a waiting list must be expelled from that list, and provisionally promoted to another list (see discussion of space 33 below).

Heading 29, ‘Automatic RFQ on Match, is associated with space 30 containing a criterion (supplied by the target enterprise) for determining conditions under which a request for price quotation (‘RFQ’) may be automatically sent to and solicited from a respective seeking entity during normal system access to the respective entry.

Heading 31, ‘Common Contacts List’, is associated with sub-headings 32 and 33. Sub-heading 32, ‘Automatic Promotion With Match’, is associated with space 33, the latter containing criteria (set by the target enterprise) for automatic promotion of the respective seeking entity to the associated trusted list if that entity is currently on a respective waiting list (see item 28 above). Sub-heading 34, ‘Notify of Match’, is associated with space 35 containing criteria (set by the target enterprise) indicating if a contact for the respective seeking entity should or should not be notified of a promotional change in status for that entity.

Heading ‘other’ at 36 refers to not-shown other information pertaining to promotion and demotion. It should be understood that some of this other information can be devoted to specifying conditions for expulsion of entries from an associated BR trusted list and/or criteria for demoting existing entries from trusted status to lesser status.

System Processes

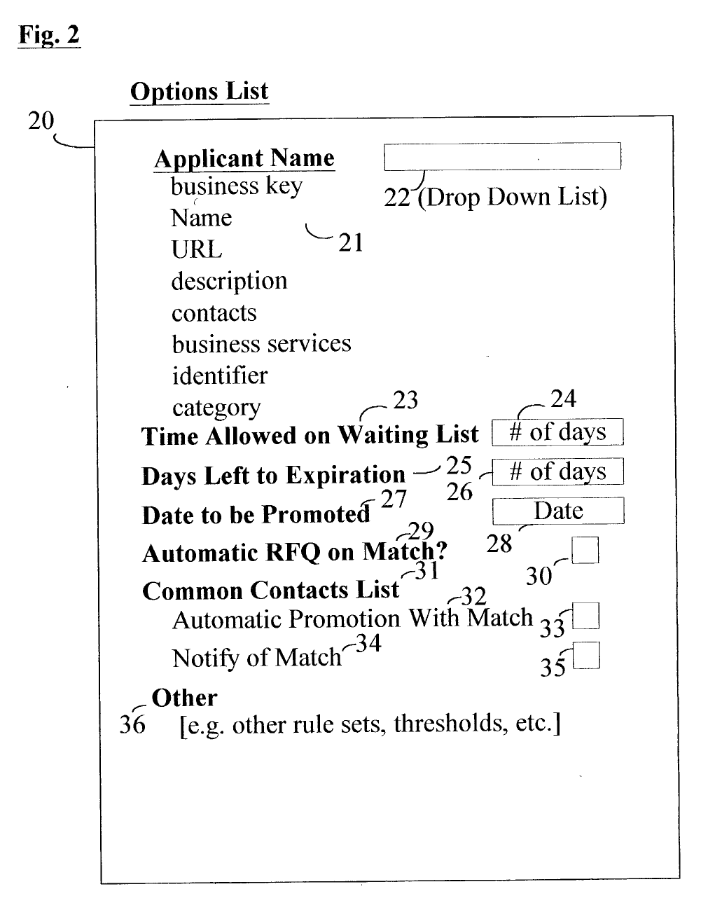

FIG. 3 contains a flowchart for explaining processes of operation in the subject system/service for evaluating BR entries in respect to promotion and demotion of their trust (member status) ratings. FIG. 4 is a flowchart for explaining details of processes suggested in general terms in FIG. 3. Where applicable, in the discussion of FIG. 4, the use of the Options List and other elements of the BR database will be explained. However, it should be understood that the Options List and other elements are also subject to access by the target enterprise when entries are not being evaluated.

FIG. 3 illustrates general elements of a process for evaluating member status ratings for promotion and/or demotion. The process includes three process elements; an ‘event driven’ element 40, an element 41 for examining rules and other criteria and applying them to individual BR entries, and an element 42 for selectively promoting and/or demoting member status ratings based on results of executing element 41. Event driven process element 40 detects occurrence of events specifically relevant to the BR and its entries; see e.g. items 23-36 FIG. 2.

Details of these process elements are shown in FIG. 4. Details of event driven processing are indicated at 50-55, details of rules and threshold examination are shown 56-60, and details of promotion/demotion processing are shown at 61-64.

At the start 50 of event driven process execution, the system maintaining the BR for the target enterprise determines, at 51, if all BR entries potentially affected by prior occurrence of a relevant event have been evaluated. If all such evaluations have been executed the process ends at 52. However, if the evaluations have not been started or completed, the system enters a waiting loop 53-55 of indefinite duration, during which it waits to detect occurrence of an event (or events) relevant to promotion and/or demotion of BR member status ratings.

When such event(s) is/are detected actions 56 are taken to fetch a BR entry and evaluate a rule set which specifies conditions under which the member status rating of that entry could be eligible for promotion or demotion. Among those conditions are one or more thresholds associated with the rule set. Relevant rule sets are suggested by entries in the options list of FIG. 2. An example of another relevant rule not suggested in FIG. 2 could, for example, be on that conditions promotion of an entry having provisional status to trusted status if and only if the respective entity has responded to three RFQ's. An associated threshold in this example would be the number 3 associated with the required number of RFQ responses.

Following operations 57, the system links (via process connectors indicated by circular symbols 57 and 58) to decision 59 at which a determination is made as to whether or not a threshold has been exceeded (or thresholds have been exceeded) at which the respective entry's member status rating should be considered for promotion or demotion. It should be understood that this determination involves consideration of both the threshold occurrence and the immediate value of the respective member status rating; i.e. if the current value is a highest trust level obviously it would not be considered for promotion, and if the current value is at a provisional level it would not be considered for demotion.

If relevant threshold has not been exceeded, or the entry status is otherwise ineligible for promotion or demotion, steps 63 are executed to update the system database and logfile relative to the entry, and the system returns to initial processing step 51 via connections indicated by circular symbols 65 and 66.

If the foregoing threshold has been exceeded, and it is one pertinent to promotion of the member status rating of the entry currently being evaluated, the system decides at 60 if the respective member status rating is subject to automatic promotion (as distinct from non-automatic handling via manual intervention of a representative of the target enterprise). If the entry is not subject to automatic promotion, operations 63 are executed, to update the system database and logfile, and the process returns to initial step 51 as noted previously. If results of decisions 59 and 60, are both positive, the member status rating of the respective BR entry is promoted to a higher trust status (step 61) and if that operation is executed successfully (positive result at decision 62), the system updates relevant entry parameters in the database and logfile (operations 63) and returns to the initial operation 51 in the manner previously noted. If the promotion process is not successfully executed, appropriate entries are made in the system's error log (step 64) and database and logfile (steps 63), and the system returns to initial operation 51.

Upon return to initial step 51, the system determines at 51 if all BR entries affected by the previously detected event have been processed. If they have not, the system passes directly through the wait loop 53-55 to fetch another entry and evaluate its member status in respect to that event. Thus, the process continues until all entries affected by an event have been evaluated and member status ratings have been selectively modified where applicable. When all entries have been processed, the process ends at 52, and later restarts at 50 after an appropriate time has passed

It is noted that decision 60 and action 61 refer both to promotion and demotion of entry status. With respect to demotion, it should be understood that the threshold considered at decision 59 has a negative context reflecting conditions under which an entry currently having trusted status could be eligible for demotion to less trusted or even provisional status.

Implementation Considerations

The foregoing processes are easily implemented by simple software-based additions to existing operating system and database application software presently in commercial use.

Those skilled in relevant arts understand that such existing software would generally support inclusion of the above-described processes; although to our knowledge no existing software has been used in this manner.

In the presently intended context, software consists of expressions, in any language, code or notation, representing computer instructions or groups of instructions which, upon execution by a computer, produce associated functions and effects in a computer. Such software is subject to installation in a computer via either removable storage media or communication networks.

Accordingly we claim:

1. A business registry data structure (BR), for use by a target business enterprise in respect to a business purpose defined by that enterprise, said BR having entries representing trust qualifications of entities associated with respective entries (hereafter ‘seeking entities’) relevant to said business purpose; said BR comprising:
a member status function associating each entry with a specific trust level, within a range of trust levels including a least trusted/provisional level and a fully trusted level; and
a set of logical criteria, subject to modification by said target enterprise at any time, for determining if a member status function for any said entry is qualified to be increased so as to effectively promote a seeking entity associated with that entry to a higher level of trust.

2. A BR in accordance with claim 1 also comprising:
means responsive to a determination that a said member status function is qualified to be increased for increasing said function and thereby promoting the respective entry to a higher level of trust.

3. A BR in accordance with claim 2 wherein said means for increasing said function operates on an automatic basis without having to inter-act with a representative of said target enterprise.

4. A BR in accordance with claim 1 wherein:
said logical criteria are contained in a list; and
said list is accessible to said target enterprise for enabling said target enterprise to modify said logical criteria.

5. A software application for managing a business registry data structure (BR) in behalf of a target business enterprise, said BR having information entries descriptive of business entities that are candidates for trusted business association with said target enterprise; the information for each said entry including a member status number denoting a level of trust instantly assigned to the respective candidate entity; said application comprising:
a list containing information including logical criteria for selectively increasing values of individual ones of said member status numbers in said BR so as to effectively promote respective candidate entries to higher levels of trust consideration;
means for utilizing said list to evaluate said information entries in said BR to determine if member status numbers of respective entries are worthy of being increased; and
means responsive to said evaluations for selectively increasing values of member status numbers of entries determined to be worthy of a higher level of trust consideration.

6. A BR management application in accordance with claim 5 including:
means providing restrictive access to said list for enabling said logical criteria to be established and modified exclusively in behalf of said target enterprise.

7. A business registry data structure (BR) for enabling a target business enterprise to ascertain trustworthiness of business entities that are candidates for trusted business dealings with the target enterprise; said BR having individual information entries for each said candidate entity; each said entry including information identifying a respective said candidate entity, the business of that entity, and a member status rating indicative of the trustworthiness of that entity; said BR further including information representing logical criteria for enabling the target enterprise to determine if any of said member status ratings merit promotion to a higher level of trustworthiness.

8. A BR in accordance with claim 7 having an associated program application for evaluating said logical criteria and for automatically modifying said member status ratings of selected said entries in association with evaluations of said criteria.
